(19) United States
(12) Patent Application Publication
(10) Pub. No.: US 2019/0367098 A1
(43) Pub. Date: Dec. 5, 2019

(54) STRUCTURAL MEMBER FOR VEHICLE

(71) Applicant: HONDA MOTOR CO., LTD., Tokyo (JP)

(72) Inventors: Kazumi MIYAKE, Wako-shi (JP); Tomoya YABU, Wako-shi (JP); Hitomi EZURA, Wako-shi (JP)

(21) Appl. No.: 16/395,898

(22) Filed: Apr. 26, 2019

(30) Foreign Application Priority Data
Jun. 1, 2018 (JP) 2018105826

(51) Int. Cl. B62D 29/00; B62D 21/15

(52) U.S. Cl. CPC B62D 29/005; B60R 19/03; B62D 21/157

(57) ABSTRACT

A structural member for a vehicle includes: a first member (2) having a channel section having an open side facing in an outboard direction, and formed by a fiber reinforced resin containing a knitted fabric (5) and a matrix resin; and a second member (3) positioned on and attached to an outboard side of the first member, and made of metallic material.

### TECHNICAL FIELD

The present invention relates to a structural member for a vehicle, and particularly relates to a vehicle structural member made of a composite material including fiber reinforced resin and metal material.

### BACKGROUND ART

It is known to form a structural member for a center pillar of a vehicle by using carbon fiber reinforced resin (see JP2005-225364A, for instance). This prior art structural member consists of a hollow pillar, and uses a woven fabric material in which carbon fibers in an ordinary woven form on the outer side of the vehicle, and a UD material (unidirectional material) in which carbon fibers are aligned in a prescribed direction on the inner side of the vehicle. At the time of a side crash, since the structural member receives a load from the outer side of the vehicle, a compressive stress is generated on the outer side of the vehicle body, and a tensile stress is generated on the inner side of the vehicle body. When a woven fabric material is used for the reinforcing fibers, the compressive strength of the fiber reinforced resin can be improved more than when a UD material is used. Conversely, when a UD material is used for the reinforcing fibers, the tensile strength of the fiber reinforced resin can be improved more than when a woven fabric material is used. Therefore, the energy absorbing characteristics of the vehicle structural member can be improved by using a woven fabric material on the outer side of the vehicle body where compressive stress is generated, and a UD material on the inner side of the vehicle body where tensile stress is generated.

In order to further improve the energy absorbing characteristics of the structural member of the vehicle body, it is effective to further improve the compressive strength of the fiber reinforced resin used on the outer side of the structural member. Therefore, there is a demand for a fiber reinforced structural member having more favorable characteristics than the fiber reinforced resin using a woven fabric material for the reinforcing fibers.

### SUMMARY OF THE INVENTION

In view of such a problem of the prior art, a primary object of the present invention is to provide a structural member for a vehicle wherein the structural member includes fiber reinforced resin and is improved in energy absorbing characteristics.

The present invention accomplishes such an object by providing a structural member for a vehicle, comprising a first member (2) having a channel cross section having an open side facing in an inboard direction, and formed by a fiber reinforced resin containing a knitted fabric (5) and a matrix resin, and a second member (3) positioned on and attached to an inboard side of the first member, and made of metallic material.

According to another aspect of the invention, s structural member for a vehicle comprises: a first member (2) having a channel section having an open side facing in a first direction, and formed by a fiber reinforced resin containing a knitted fabric (5); and a second member (3) positioned on a side of the first member in the first direction, and attached to the first member, the second member being made of metallic material, the first member being positioned on an outboard side of the second member.

When a knitted fabric is used for the reinforcing fibers in the fiber reinforced resin, the compressive strength can be improved. Therefore, by using a knitted fabric for the fiber reinforced resin, the mechanical strength of the first member which is positioned on the outboard side and is hence subjected to a compressive load at the time of a crash can be effectively improved. The tensile strength of the second member which is subjected to a tensile load at the time of a crash can be ensured by using the metallic material for the second member. Thus, the present invention as defined above can improve the energy absorbing characteristics of the structural member for a vehicle.

Preferably, the first member includes a top wall (2A), a pair of side walls (2B) extending upright from respective side edges of the top wall, and a pair flanges (2C) extending from free end edges of the respective side walls away from each other, and the second member is connected to the flanges.

Thereby, the connection between the first member and the second member can be simplified so as to facilitate the manufacture of the vehicle structural member, and a mechanical strength of the structural member can be ensured.

Preferably, the first member and the second member jointly define a closed cross section.

Thereby, the bending stiffness (strength) of the structural member can be improved.

Preferably, the second member includes a part in surface contact with the top wall, and a part in surface contact with the side walls.

Thereby, the volume of the structural member can be minimized so that the structural member can be used in various parts of the vehicle where available space may be limited.

Preferably, the knitted fabric is contained in the top wall, the side walls and the flanges, and the knitted fabric contained in the top wall, the side walls and the flanges consists of a continuous sheet of fabric.

Thereby, the compressive strength of the first member can be maximized.

Preferably, the knitted fabric is given with a three dimensional configuration conforming to the top wall, the side walls and the flanges.

Thereby, the fabric is not required to be cut or sewn during the manufacturing process so that the manufacturing work can be facilitated. Also, the waste of the woven fabric can be minimized.

Preferably, the knitted fabric comprises a pair of mutually opposing layers (5A) in a spaced apart relationship, and connecting portions (5B) connecting the two layers to each other.

Thereby, the compressive strength of the first member can be particularly improved.

The second member may be provided with variously different configurations, such as a planar sheet member attached to the flanges of the first member, a channel member having an open side facing the open side of the first member, and attached to the flanges of the first member, and a closed cross section member attached to the flanges of the first member. These options may be selected depending on the particular needs.

The present invention thus provides a structural member for a vehicle wherein the structural member includes fiber reinforced resin and is improved in energy absorbing characteristics.

### BRIEF DESCRIPTION OF THE DRAWING(S)

FIG. 1 is a perspective view of a structural member for a vehicle according to a first embodiment of the present invention;

FIG. 2 is a cross sectional view of the structural member;

FIG. 3 is a cross sectional view of knitted fabric;

FIG. 4 is a simplified side view of a vehicle body;

FIG. 5 is a perspective view of a front bumper;

FIG. 6 is a perspective view of a rear bumper;

FIG. 7 is a perspective view illustrating a moment and a load generated in the structural member at the time of a crash;

FIG. 8 is a graph showing the results of compressive strength tests;

FIG. 9 is a diagram illustrating an arrangement for a static and a dynamic four-point bending test;

FIG. 10 is a graph showing the results of the static four-point bending test;

FIG. 11 is a graph showing the results of the dynamic four-point bending test;

FIG. 12 is a cross sectional view of a structural member for a vehicle according to a second embodiment;

FIG. 13 is a cross sectional view of a structural member for a vehicle according to a third embodiment; and

FIG. 14 is a cross sectional view of a structural member for a vehicle according to a fourth embodiment.

### DESCRIPTION OF THE PREFERRED EMBODIMENT(S)

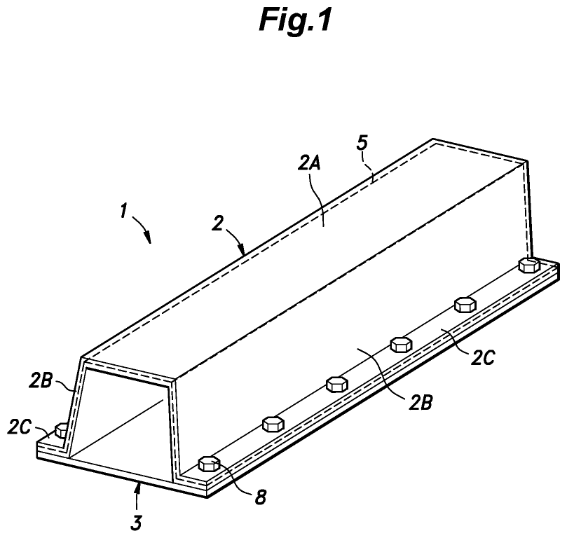

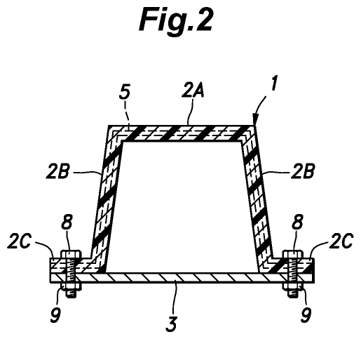

A structural member according to a first embodiment of the present invention is described in the following with reference to FIGS. 1 and 2. This structural member consists of an elongated member which may serve as a beam member designed to withstand bending loading. This structural member may be used on a front end, a rear end or a side end of a vehicle body, and may form, not exclusively, a pillar or a side sill.

As shown in FIG. 1 and FIG. 2, the structural member 1 according to the first embodiment includes a first member 2 and a second member 3 which are joined to each other. The first member 2 is formed of a fiber reinforced resin including fibers and a matrix resin impregnated in the fibers. The fibers may be, not exclusively, glass fibers, carbon fibers, boron fibers or aramid fibers. The matrix resin may be a thermosetting resin such as epoxy resin, unsaturated polyester resin, and vinyl ester resin, or a thermoplastic resin such as nylon resin and ABS resin.

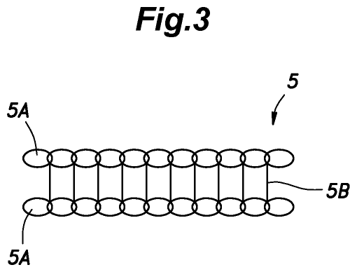

In this embodiment, the fibers are formed into a knitted fabric 5. The knitted fabric 5 may be formed by weft knitting such as plain knitting (Jersey knitting), rib stitching and purl stitching, or warp knitting such as single Denbigh knitting. Further, as shown in FIG. 3, the knitted fabric 5 may have a plurality of layers 5A facing each other in a spaced apart relationship, and connecting portions 5B connecting the adjoining layers 5A to one another. In the illustrated embodiment, the number of the layers 5A is two. The knitted fabric 5 before impregnation with the matrix resin preferably has a void ratio of 65% to 85% (fiber volume ratio of 15% to 35%) at atmospheric pressure, for instance.

As shown in FIGS. 1 and 2, the first member 2 has a top wall 2A, a pair of side walls 2B extending upright from the respective side edges of the top wall 2A, and a pair of flanges 2C extending from the free end edges of the respective side walls 2B. The first member 2 thus has a hat-shaped cross section (channel cross section). The open side of the first member is referred to as a first direction which is typically directed in the inboard direction. The top wall 2A, the side walls 2B, and the flanges 2C are each formed in a flat plate shape, and extend in a predetermined direction. The side walls 2B extend obliquely from the top wall 2A so as to be progressively spaced away from each other toward the respective flanges 2C. In another embodiment, the side walls 2B extend parallel to each other. The flanges 2C may be disposed on a common imaginary plane, but may also be offset from each other.

The fibers are formed into a single continuous sheet of knitted fabric 5, which extends along the top wall 2A, the side walls 2B, and the flanges 2C. The knitted fabric 5 may have a three-dimensional shape corresponding to or conforming to the top wall 2A, the side walls 2B, and the flanges 2C.

The first member 2 may be formed, for example, by vacuum assisted resin transfer molding (VaRTM). In the vacuum assisted resin transfer molding, the knitted fabric 5 is placed in a molding die, and the matrix resin is drawn into the molding die by evacuating the inner cavity of the molding die to impregnate the knitted fabric 5 with the matrix resin. It is preferable that the knitted fabric 5 placed in the forming mold is knitted in a predetermined three-dimensional shape so as to eliminate the need to cut and sew the knitted fabric in advance.

The second member 3 is formed of a metallic member. The metallic member may be, not exclusively, an iron alloy such as stainless steel, an aluminum alloy, or a magnesium alloy. The second member 3 is positioned in the first direction (inboard direction) with respect to the first member 2 and is attached to the first member 2. In the first embodiment, the second member 3 is formed in a plate shape, and is attached to the first member 2 so as to close the opening of the first member 2. The second member 3 extends along the first member 2 and abuts on the flanges 2C of the first member 2 at the corresponding side edges thereof The first member 2 and the second member 3 are fastened to each other by a plurality of bolts 8 penetrating the edges of the flanges 2C of the first member 2 and the second member 3, and a plurality of nuts 9 are threaded onto the corresponding bolts 8. In another embodiment, the flanges 2C of the first member 2 and the corresponding edges of the second member 3 are fastened to each other by using rivets. In yet another embodiment, the flanges 2C of the first member 2 and the corresponding edges of the second member 3 are bonded to each other by using an adhesive agent.

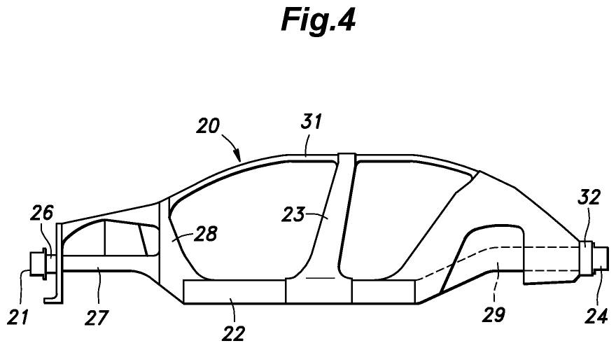

As shown in FIG. 4, the structural member 1 may be used on the front side, the rear side, the left side or the right of the vehicle body 20, and the first member 2 is placed on the outboard side of the second member 3 so as to favorably oppose a loading applied to vehicle body 20 from outside as is often the case at the time of a crash. The structural member 1 may have a bend in a part thereof, or may be curved so as conform to the profile of the vehicle body 20 or to meet any other requirements. Typically, a structural member provided on an outer side of the vehicle body 20 is curved so as to face the convex side thereof in the outboard direction. Also, the structural member 1 according to the present invention may be advantageously utilized as a part of a front bumper 21, a side sill 22, a center pillar 23, or a rear bumper 24.

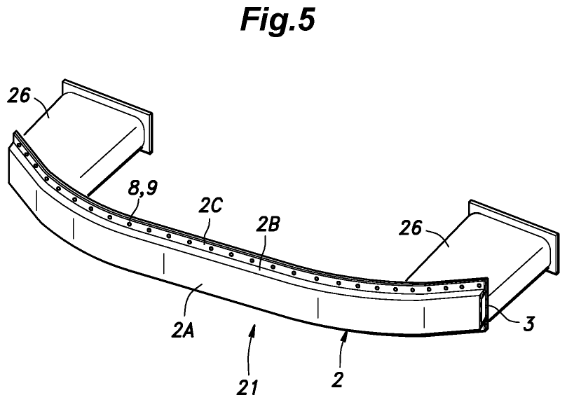

As shown in FIGS. 4 and 5, in the front bumper 21 formed by the structural member 1, the first member 2 is disposed in front of the second member 3 (or on the inboard side of the vehicle body 20), and the first member 2 and the second member 3 extend in the lateral direction. The outer surface (rear surface) of the second member 3 of the front bumper 21 is attached to the front ends of a pair of left and right front side frames 27 extending in the fore and aft direction in a lower front part of the vehicle body 20 via a pair of left and right bumper stays 26. The bumper stays 26 and the second member 3 are joined to each other by welding, or fastening using threaded bolts or the likes. The first member 2 and the second member 3 are curved such that the laterally central parts thereof protrude forward with respect to the lateral ends thereof, and a forwardly convex bumper is formed.

As shown in FIG. 4, in the side sill 22 formed by the vehicle structural member 1, the first member 2 is disposed outward (outboard) of the second member 3 in the lateral direction of the vehicle body 20. The first member 2 and second member 3 extend in the fore and aft direction. The front ends of the first member 2 and the second member 3 of the side sill 22 are connected to a lower end part of a front pillar 28 extending vertically along the side of the vehicle body 20, and the rear end of the second member 3 of the side sill 22 is connected to the front end of the rear side frame 29 also extending in the fore and aft direction in a lower rear part of the vehicle body 20. The first member 2 is joined to the front pillar 28 by using fasteners such as threaded bolts or by using an adhesive agent. The second member 3 may be joined to the front pillar 28 and the rear side frame 29 by using fasteners such as threaded bolts, by using an adhesive agent or by welding.

In the center pillar 23 formed by the vehicle structural member 1, the first member 2 is disposed outward (outboard) of the second member 3 with respect to the lateral direction of the vehicle body 20, and the first member 2 and the second member 3 extend vertically. The upper ends of the first member 2 and the second member 3 of the center pillar 23 are joined to an intermediate part of a roof side member 31 extending in the fore and aft direction on an upper side of the vehicle body 20. The lower ends of the first member 2 and the second member 3 are joined to an intermediate part of the side sill 22. The first member 2 is joined to the roof side member 31 and the side sill 22 by using fasteners such as threaded bolts or by using an adhesive agent. The second member 3 is joined to the roof side member 31 and the side sill 22 by using fasteners such as threaded bolts, by using an adhesive agent or by welding.

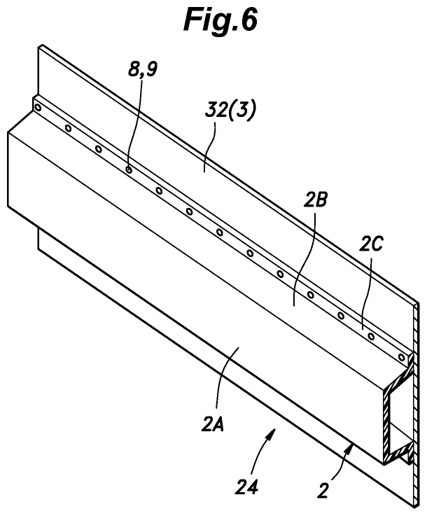

As shown in FIGS. 4 and 6, the rear bumper 24 forms the vehicle structural member 1 jointly with a cross member 32. The cross member 32 extends in the lateral direction, and is joined to the rear ends of the rear side frames 29 at either lateral end part thereof. The cross member 32 is a metallic sheet member having a major plane facing in the fore and aft direction. The second member 3 of the structural member 1 is formed by the cross member 32. In other words, the structural member 1 is formed jointly by the first member 2 and the cross member 32 which serves as the second member 3. The first member 2 abuts on and is attached to the rear surface of the cross member 32 at the flanges 2C extending along upper and lower edges of the first member 2. Thus, the first member 2 is disposed rearward (outboard) with respect to the cross member 32 (second member 3). The first member 2 and the cross member 32 may joined to each other by using fasteners such as threaded bolts or by using an adhesive agent.

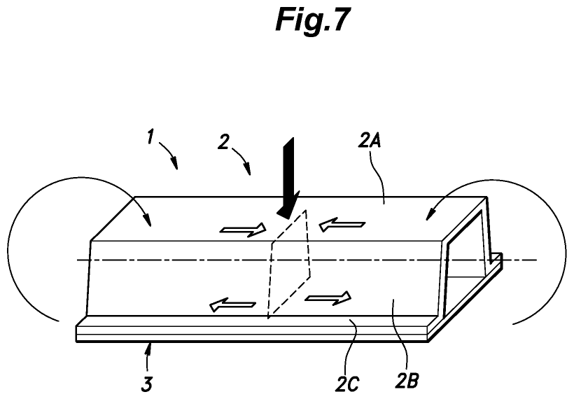

The behavior of the structural member 1 when a crash load is applied thereto is discussed in the following with reference to FIG. 7. The first member 2 is disposed outward of the second member 3 in the structural member 1. Therefore, at the time of a crash, the crash load is applied to the top wall 2A of the first member 2, and pushes the structural member 1 inward of the vehicle body 20. As a result, a bending moment is generated in the structural member 1 so that a compressive stress is generated in the longitudinal direction of the first member 2, and a tensile stress is generated in the longitudinal direction of the second member 3. Thus, by increasing the compression strength of the first member 2, the bending strength of the structural member 1 is improved in a corresponding manner, and so is the energy absorbing capability of the structural member 1. Further, also by increasing the tensile strength of the second member 3, the bending strength of the vehicle structural member 1 can be improved, and so is the energy absorbing capability of the structural member 1.

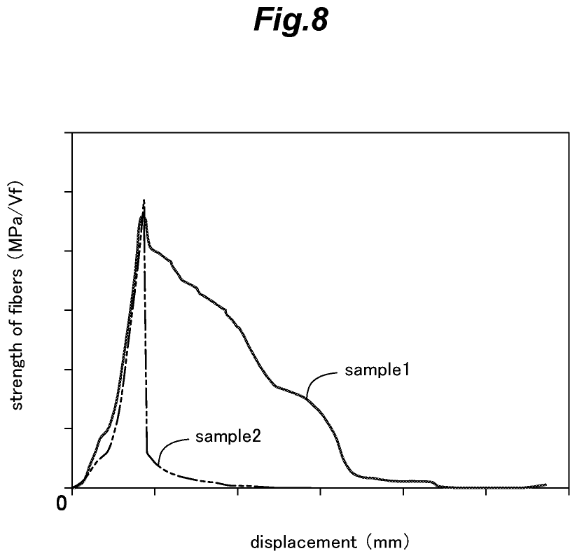

FIG. 8 is a graph showing the results of the compressive strength test of the fiber reinforced resin. Sample 1 is a fiber reinforced resin in which the fibers are in the form of a knitted fabric, and Sample 2 is a fiber reinforced resin in which the fibers are in the form of s woven fabric. Samples 1 and 2 differ only in the structure of the fibers, and the fiber volume ratio Vf [%], but are otherwise similar to each other. In Samples 1 and 2, the fibers consist of glass fibers and the matrix resin consists of epoxy resin. The knitted fabric of Sample 1 has two layers of knitted fabric which are connected to each other by connecting portions (see FIG. 3). The fibers of Sample 2 are formed as a plain woven fabric. In Samples 1 and 2, the knitted fabric and the woven fabric are aligned with the compression direction. The fiber volume ratio Vf of Sample 1 is 32%, and the fiber volume ratio Vf of Sample 2 is 51%.

As shown in FIG. 8, Samples 1 and 2 demonstrated a substantially same yield strength (compressive strength). However, in Sample 2, the compressive strength sharply decreased after the yield point is reached, whereas in Sample 1, the compressive strength decreased only gradually after the yield point is reached. In other words, Sample 2 essentially failed immediately after the yield point is reached, whereas Sample 1 undergoes plastic deformation, but continues to absorb energy after the yield point is reached. Therefore, it can be concluded that Sample 1 has a greater energy absorbing capability than Sample 2. It means that the use of a knitted fabric in the part of the structural member 1 which is subjected to compressive stress improves the energy absorbing capability of the structural member 1 as compared to the case where a woven fabric is used.

Static and dynamic bending tests were performed on Sample 3 according to the present invention and Sample 4 given as an example for comparison. Sample 3 is a structural member 1 according to the first embodiment described above (see FIG. 1), and the first member 2 contains a knitted fabric made of glass fibers for the reinforcing fibers, and epoxy resin for the matrix resin. The second member 3 is made of an aluminum alloy. The knitted fabric 5 has two layers 5A and connecting portions 5B connecting the two layers 5A to each other. Sample 4 given as an example for comparison differs from Sample 3 only in the structure of the reinforcing fibers and the fiber volume ratio Vf [%], but is otherwise similar to Example 3. In Sample 4, the reinforcing fibers are formed into a plain weave woven fabric. The fiber volume ratio Vf of Sample 3 is 32%, and the fiber volume ratio Vf of the sample 4 is 51%.

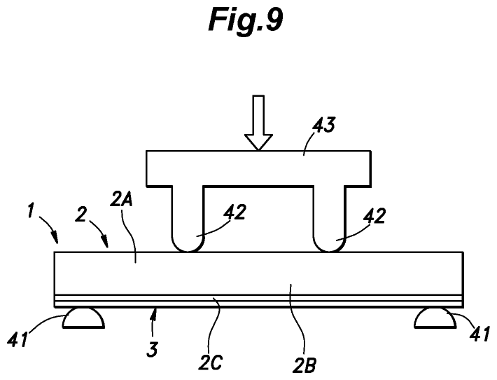

As shown in FIG. 9, in the bending test, Samples 3 and 4 were placed on two supporting pins 41 with the second member 3 placed on the lower side, and a loading head 43 were pressed downward on middle parts of the first member 2 from above via a pair of loading pins 42. Assuming that the length of the Samples 3 and 4 is 10, the distance between the two supporting pins 41 was 9, and the distance between the two loading pins 42 was 4. In the static bending test, the loading head 43 was displaced downward at 10 mm/min. In the dynamic bending test, the loading head 43 was dropped from above to cause the loading pins 42 to collide with Samples 3 and 4.

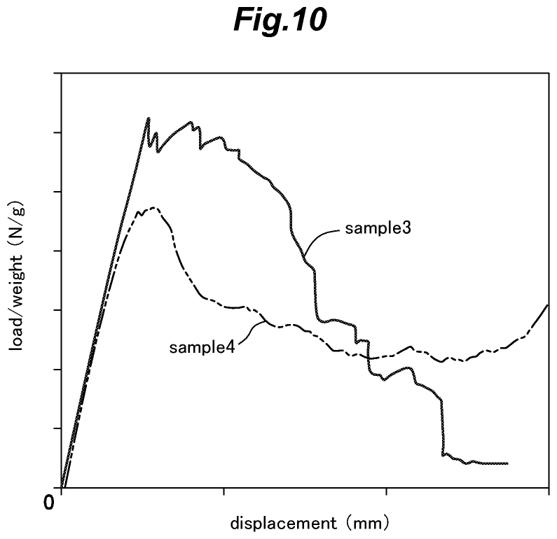

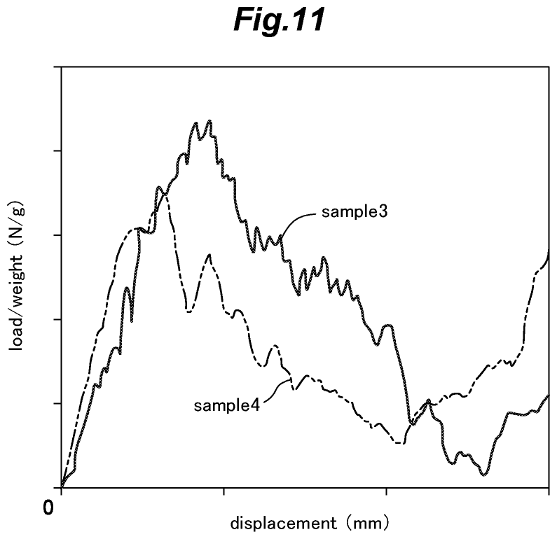

From the results of the static bending test shown in FIG. 10 and the dynamic bending test shown in FIG. 11, it can be seen that Sample 3 has a greater bending strength than Sample 4. Also, it can be seen that the bending strength of Sample 3 is maintained even after the yield point is reached as opposed to Sample 4 which quickly loses the bending strength once the yield point is reached. It means that Sample 3 has a greater energy absorbing capability than Sample 4. The integration of the loading with respect to displacement in the graphs in FIGS. 10 and 11 corresponds to the amount of the absorbed energy.

In the structural member 1 configured as described above, the fibers of the first member 2 disposed on the outer side (outboard side) of the vehicle are formed as a knitted fabric so that the compressive strength of the part where compressive stress is generated at the time of a crash can be improved. On the other hand, since the second member 3 disposed on the inner side (inboard side) of the vehicle is formed of a metallic member, it is possible to improve the tensile strength of the part where tensile stress is generated at the time of a crash. Thus, according to the present invention, the energy absorbing characteristic of the vehicle structural member 1 can be improved.

Since the knitted fabric 5 has the two layers 5A facing each other in a spaced apart relationship and the connecting portions 5B connecting the two layers 5A, the compressive strength of the first member 2 can be improved. Since the fibers are generally looped in the knitted fabric 5, the fibers are allowed to move relative to one another when loaded so as to absorb energy. The connecting portions 5B allow the movement of the layers 5A relative to each other, and this further contributes to absorbing energy.

Since the knitted fabric 5 is provided with a three-dimensional shape corresponding to the top wall 2A, the side walls 2B, and the flanges 2C, the knitted fabric 5 is not required to be cut and sewed at the time of manufacture so that the manufacturing operation is simplified. Furthermore, wastage of material can be minimized.

The second to fourth embodiments of the present invention are described in the following. The structural members 40, 50 and 60 of the second to fourth embodiments differ from the structural member 1 of the first embodiment in the configuration of the second member 3, but are otherwise similar to the structural member 1 of the first embodiment

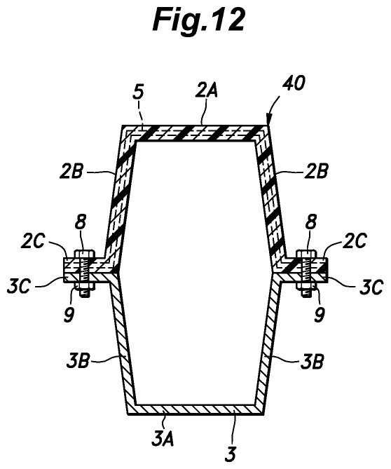

As shown in FIG. 12, the second member 3 of the structural member 40 according to the second embodiment includes a top wall 3A, a pair of side walls 3B extending upright from respective side edges of the top wall 3A, and a pair of flanges 3C extending from the free ends of the respective side walls 3B away from each other, so that a hat shaped cross section is defined. The second member 3 is fastened to the flanges 2C of the first member 2 at the respective flanges 3C of the second member 3. The top wall 3A of the second member 3 is disposed on the remote side of the first member 2 with respect to the flanges 3C. Thus, the second member 3 in the second embodiment includes a channel member attached to the flanges 2C of the first member 2, and having an open side facing the open side of the first member 2. According to the second embodiment, the bending strength (stiffness) of the second member 3 can be improved by introducing the three-dimensional shape to the second member 3 so that the bending strength (stiffness) of the structural member 40 can be improved.

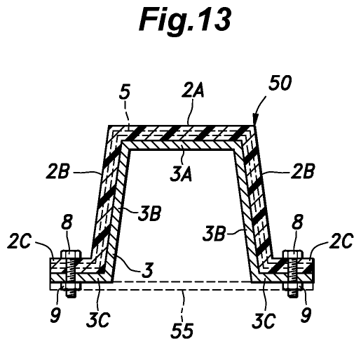

As shown in FIG. 13, the second member 3 of the structural member 50 according to the third embodiment has a top wall 3A, a pair of side walls 3B, and a pair of flanges 3C, so that a hat shaped cross section is defined. The second member 3 is fastened to the flanges 2C of the first member 2 at the respective flanges 3C thereof. The top wall 3A of the second member 3 is disposed on the side of the first member 2 with respect to the flanges 3C. The top wall 3A of the second member 3 makes surface contact with the top wall 2A of the first member 2 at least in part, and the side walls 3B of the second member 3 at least in part make a surface contact with the respective side walls 2B of the first member 2. According to the third embodiment, the volume of the structural member 50 can be minimized. Therefore, the structural member 50 can be used in various parts of the vehicle body 20 where available space is limited. A third member 55 may be attached to the second member 3 so that a closed cross section may be formed in cooperation with the second member 3. The third member 55 may be formed to have a hat shape or a flat plate shape. The third member 55 may be fastened together to the first member 2 and the second member 3 by using threaded bolts 8 and nuts 9.

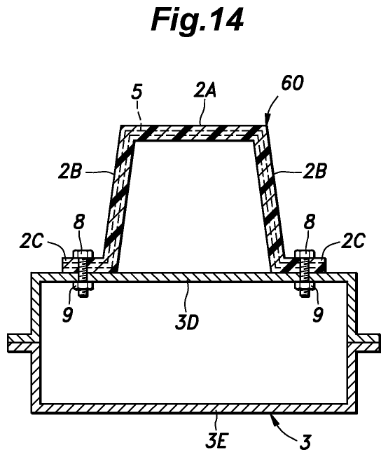

As shown in FIG. 14, the second member 3 of the structural member 60 according to the fourth embodiment has a closed cross section. The second member 3 may include a first half 3D and a second half 3E coupled to each other so as to jointly form a closed cross section. The flanges 2C of the first member 2 may be attached to at least one of the first half 3D and the second half 3E.

Although the present invention has been described in terms of specific embodiments, the present invention is not limited by such embodiments, but can be modified in various ways without departing from the spirit of the present invention. For example, the structural member 1 may be disposed inside a door panel. For example, the structural member 1 may be disposed between an inner panel and an outer panel constituting the door panel, and may extend in the fore and aft direction to connect the front end and the rear end of the door panel. The structure of the knitted fabric 5 of the first member 2 can be freely selected, and various knitted structures other than those mentioned above can also be applied.

1. A structural member for a vehicle, comprising:
a first member having a channel cross section having an open side facing in an inboard direction, and formed by a fiber reinforced resin containing a knitted fabric and a matrix resin; and
a second member positioned on and attached to an inboard side of the first member, and made of metallic material.

2. The structural member according to claim 1, wherein the first member includes a top wall, a pair of side walls extending upright from respective side edges of the top wall, and a pair flanges extending from free end edges of the respective side walls away from each other, and the second member is connected to the flanges.

3. The structural member according to claim 2, wherein the first member and the second member jointly define a closed cross section.

4. The structural member according to claim 3, wherein the second member comprises a planar sheet member attached to the flanges of the first member.

5. The structural member according to claim 3, wherein the second member comprises a channel member attached to the flanges of the first member, and having an open side facing the open side of the first member.

6. The structural member according to claim 3, wherein the second member comprises a closed cross section member attached to the flanges of the first member.

7. The structural member according to claim 2, wherein the second member includes a part in surface contact with the top wall, and a part in surface contact with the side walls.

8. The structural member according to claim 2, wherein the knitted fabric is contained in the top wall, the side walls and the flanges.

9. The structural member according to claim 8, wherein the knitted fabric contained in the top wall, the side walls and the flanges consists of a continuous sheet of fabric.

10. The structural member according to claim 9, wherein the knitted fabric is given with a three dimensional configuration conforming to the top wall, the side walls and the flanges.

11. The structural member according to claim 1, wherein the knitted fabric comprises a pair of mutually opposing layers in a spaced apart relationship, and connecting portions connecting the two layers to each other.
